(19) United States
(12) Patent Application Publication
(10) Pub. No.: US 2025/0229715 A1
(43) Pub. Date: Jul. 17, 2025

(54) VEHICLE SIDE-VIEW MIRROR SYSTEM CAPABLE OF CHECKING FRONT IN ADJACENT LANE

(71) Applicant: Dong Il KIM, Gangwondo (KR)

(72) Inventor: Dong Il KIM, Gangwondo (KR)

(21) Appl. No.: 18/555,786

(22) PCT Filed: Nov. 16, 2022
(86) PCT No.: PCT/KR2022/018045

§ 371 Date: Apr. 8, 2025

(30) Foreign Application Priority Data
Aug. 8, 2022 (KR) 10-2022-0098314

(51) Int. Cl. B60R 1/24; B60R 1/00; B60R 1/12

(52) U.S. Cl. CPC B60R 1/24; B60R 1/007; B60R 1/12; B60R 2001/1253; B60R 2300/804

(57) ABSTRACT

A vehicle side-view mirror system capable of checking the front in an adjacent lane is proposed. The vehicle side-view mirror system is characterized to include a side-view mirror unit, a camera unit built into the side-view mirror unit to capture a view ahead of a vehicle, a bracket unit for supporting the camera unit and fastening the camera unit to the side-view mirror unit, and a display unit for displaying images captured by the camera unit.

### TECHNICAL FIELD

The present disclosure relates to a vehicle side-view mirror system capable of checking the front in an adjacent lane and, more particularly, to a vehicle side-view mirror system capable of checking the front in an adjacent lane, wherein a forward-facing camera built into a side-view mirror of a vehicle is provided to enable a driver to easily check situations of other vehicles in front of a passenger seat where the driver's view is difficult to be secured.

### BACKGROUND ART

Unless otherwise indicated in the present specification, the content described in this identification item is not related art to the claims of this application and is not admitted to be the related art by inclusion in this identification item.

Recently, cases where vehicles frequently change lanes on roads have been found, and in a large proportion of these cases, the reason is that drivers, who assume that traffic in lanes to be changed would be flowing smoother than those of the current lanes, change lanes, but return to the previous lane because the vehicle traffic in the changed lanes is not smooth.

In addition, there are many cases in which a vehicle changes the current lane to the rightmost lane in order to turn right, but hastily changes from the changed lane back to the previous lane due to a vehicle illegally parked in the rightmost lane.

In case of a left lane next to a driver's seat, a traffic situation is observable by a driver, but in case of a lane next to a passenger's seat side, a traffic situation ahead in an adjacent lane is difficult to be recognized through the field of view from the driver's seat, so there are some limits to accurately observing the traffic situation ahead in the lane next to the passenger's seat side.

Accordingly, inventive embodiments for checking the situations of vehicles on a passenger's seat side by providing a camera on a side surface of a vehicle have been proposed.

As an example of such a camera for checking the situations of vehicles, Korean Utility Model Registration No. 20-0283997 (registered on Jul. 19, 2002) discloses a vehicle camera device, titled as “CAMERA SYSTEM FOR CAR”, configured to include: cameras rotatably provided on both sides of a bumper part of a vehicle; a steering wheel detection sensor for detecting and inputting an angle of rotation of the vehicle steering wheel; a controller for controlling protrusion and rotation of each camera and controlling output of images captured by each camera; a display on which the images output through the controller are displayed; and an operation switch unit provided with a plurality of operation switches enabling control of an operation of each camera according to driving conditions of a user's vehicle.

However, the above-described vehicle camera device has a problem that it is difficult to secure a photographing angle to check the situations of vehicles in front of a passenger seat because the cameras are provided on the bumper part of the vehicle.

In addition, as an example of a camera provided in a side-view mirror on a passenger seat side, Korean Patent Application Publication No. 10-2007-0056314 (published on Jun. 4, 2007) discloses an “APPARATUS FOR DETECTING FRONT AND SIDE OF VEHICLES”, configured to include: first camera units installed on both left and right sides of a vehicle; a second camera unit installed on an upper end of the vehicle; an image processor electrically connected to the first camera units and the second camera unit to process image data captured by each camera; an image display unit for displaying the image data processed by the image processor; and a controller for controlling an operation of each component, wherein the first camera units are installed on respective side-view mirrors of the vehicle.

In addition, Korean Utility Model Registration No. 20-0374137 (registered on Jan. 14, 2005) discloses a camera for monitoring vehicle blind spot, the camera including: a lens unit provided therein on a front side of a tubular-shaped housing; and a fastening ring equipped therewith for enabling installation in a vehicle by moving screw units formed on an outer periphery of the housing, wherein the housing is configured to include: a lens body and an image signal processor, which are mounted on an inner side thereof; a stepped unit protruding integrally from an outer central part thereof; first and second screw units respectively formed on both front and rear relative to the stepped unit as a center; a third screw unit inwardly formed as a fault at a rear end part of the second screw unit of the housing; a rear cover provided on the third screw unit; the front cover formed with an opening and provided with a catch unit bent inwardly on the first screw unit of the housing; a protective window for protecting a lens protruding outward from the catch unit of the front cover; and the fastening ring fastened and fixed to the second screw unit of the housing.

However, in case of the camera installed on the side-view mirror on the passenger seat side shown in the above-described reference documents, the camera protrudes outwardly from the side-view mirror and causes air resistance, and also a main intended function of the above-described camera is for checking situations of vehicles behind, so there are still many problems in checking the situations of vehicles ahead in an adjacent lane.

Accordingly, it is required to develop a side-view mirror system provided with a camera disposed inside a side-view mirror on a passenger seat side to face the front toward which direction a vehicle drives, so that a driver may easily check a traffic situation ahead in the adjacent lane.

### DISCLOSURE

### Technical Problem

In order to solve the above problem, an objective of the present disclosure is to provide a vehicle side-view mirror system capable of checking the front in an adjacent lane, and the vehicle side-view mirror system is configured to include: a side-view mirror unit; a camera unit built into the side-view mirror unit to capture a view ahead of a vehicle; a bracket unit for supporting the camera unit and fastening the camera unit to the side-view mirror unit; and a display unit for displaying images captured by the camera unit to a driver, so as to not only check a vehicle traffic situation ahead in the adjacent lane on a passenger seat side where the driver's view is difficult to be secured, but also to prevent an aesthetic problem from occurring without causing air resistance due to the camera not protruding out of the side-view mirror.

### Technical Solution

According to an exemplary embodiment of the present disclosure for achieving the above objective, there is provided a vehicle side-view mirror system capable of checking the front in an adjacent lane, the system including: a side-view mirror unit; a camera unit built into the side-view mirror unit to capture a view ahead of a vehicle; a bracket unit for supporting the camera unit and fastening the camera unit to the side-view mirror unit; and a display unit for displaying images captured by the camera unit

In addition, according to the present disclosure, the bracket unit may include a bracket main body composed of a first step fastened to the camera unit and a second step adjacent to and connected to the first step and fastened to the side-view mirror unit, and the bracket main body may be disposed to cover one surface of the camera unit and a side surface adjacent to the one surface.

In addition, according to the present disclosure, the first step may include: a first fastening screw for fastening the camera unit and the first step to each other; and a first fastening hole into which the first fastening screw is inserted and fixed, and the first fastening hole may be configured as a through hole in a longitudinal direction so as to allow a fixing position of the first fastening screw to be adjusted.

In addition, according to the present disclosure, the second step may include: a second fastening screw for fastening the side-view mirror unit and the first step to each other; and a second fastening hole into which the second fastening screw is inserted and fixed, and the second fastening hole may be configured as a through hole in a longitudinal direction so as to allow a fixing position of the second fastening screw to be adjusted.

In addition, according to the present disclosure, the side-view mirror unit may include: a main body; and a transmission window made of a transparent material and provided on one side of the main body facing the front in the adjacent lane.

In addition, according to the present disclosure, in the camera unit, a lens may be disposed adjacent to the transmission window.

In addition, according to the present disclosure, the vehicle side-view mirror system capable of checking the front in the adjacent lane may further include: a tilting unit coupled to a rear end of the camera unit and configured to adjust the front photographing angle and a photographing position of the camera unit by rotating the camera unit vertically and horizontally; and a controller for controlling operations of the camera unit and the tilting unit.

### Advantageous Effects

According to the vehicle side-view mirror system capable of checking the front in the adjacent lane according to the present disclosure as described above, the vehicle side-view mirror system is provided with a camera disposed inside a side-view mirror on a passenger seat side to face the front toward which direction a vehicle drives, thereby having an effect of not only checking a vehicle traffic situation ahead in the adjacent lane on the passenger seat side where a driver's view is difficult to be secured, but also preventing an aesthetic problem from occurring without causing air resistance due to the camera not protruding out of the side-view mirror.

The effects of the present disclosure are not limited to the above-mentioned effect, and other effects not described above will be clearly understood by those skilled in the art from the description of the claims.

### DESCRIPTION OF DRAWINGS

FIG. 1 is a perspective view and use state view illustrating a vehicle side-view mirror system capable of checking the front in an adjacent lane according to an exemplary embodiment of the present disclosure.

FIG. 2 is a configuration view illustrating the vehicle side-view mirror system capable of checking the front in the adjacent lane according to the exemplary embodiment of the present disclosure.

FIG. 3 is a perspective view illustrating a side-view mirror unit according to the exemplary embodiment of the present disclosure.

FIG. 4 is a configuration view illustrating a camera unit and a bracket unit according to the exemplary embodiment of the present disclosure.

FIG. 5 is a use state view illustrating a display unit according to the exemplary embodiment of the present disclosure.

FIG. 6 is a block diagram illustrating a use state of a tilting unit and a controller according to the exemplary embodiment of the present disclosure.

### BEST MODE

Hereinafter, an exemplary embodiment of the present disclosure is described with reference to the accompanying drawings. First of all, it should be noted that the same components or parts in the drawings are denoted by the same reference numerals as much as possible. In describing the present disclosure, detailed descriptions of related known functions or components are omitted so as not to obscure the gist of the present disclosure.

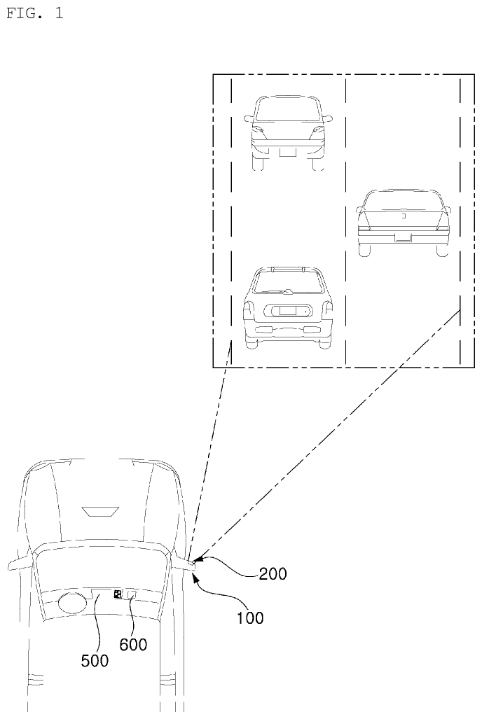

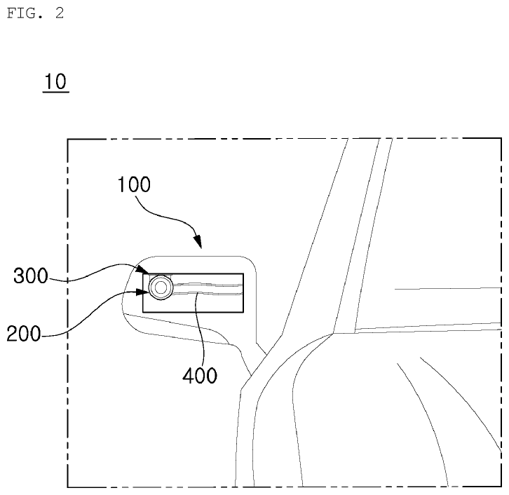

FIG. 1 is a perspective view and use state view illustrating a vehicle side-view mirror system capable of checking the front in an adjacent lane according to the exemplary embodiment of the present disclosure, and FIG. 2 is a configuration view illustrating the vehicle side-view mirror system capable of checking the front in the adjacent lane according to the exemplary embodiment of the present disclosure.

As shown in FIGS. 1 and 2, according to the present disclosure, the vehicle side-view mirror system capable of checking the front in the adjacent lane may include a side-view mirror unit 100, a camera unit 200, a bracket unit 300, a display unit 500, a connecting end line 400, a controller 600, and a tilting unit 700.

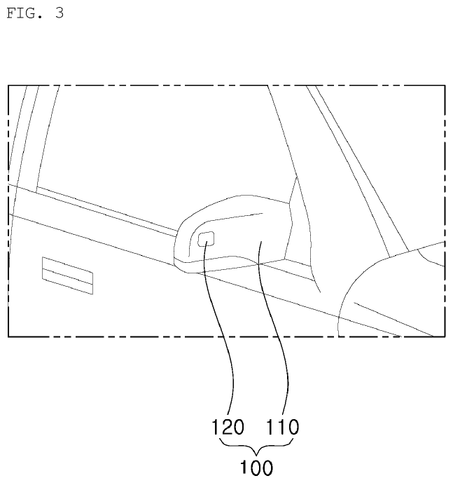

FIG. 3 is a perspective view illustrating the side-view mirror unit according to the exemplary embodiment of the present disclosure.

The side-view mirror unit 100 according to the present disclosure may include: a side-view mirror main body 110; and a transmission window 120 made of a transparent material and provided on one side of the main body facing the front in an adjacent lane.

The transmission window 120 is disposed on one surface facing forward in the side-view mirror main body 110, and may be made of a transparent material so as to allow a lens 220 of the camera unit 200 built in the side-view mirror unit 100 to be disposed adjacently thereto and enable capturing a view ahead of a vehicle.

Accordingly, it may be preferable that the transmission window 120 is made of a material enabling protecting of the lens 220 from an external environment as well as capturing of a view through the lens 220.

The camera unit 200 may be built into the side-view mirror unit 100 so as to capture a view ahead of a vehicle.

In addition, the camera unit 200 is composed of a camera main body 210 and a lens 220, wherein the lens 220 may be disposed adjacent to the transmission window 120 so as to face the front toward which direction the vehicle drives.

Accordingly, the camera unit 200 is configured to capture the front in an adjacent lane on a passenger seat side and transmit the captured images to the display unit 500, so that a driver may recognize a traffic situation ahead in the adjacent lane through the display unit 500 and then safely perform lane change.

In this way, the driver may recognize a traffic situation behind in an adjacent lane through a mirror of the side-view mirror unit 100 when changing a lane, and may check a traffic situation ahead in the adjacent lane captured by the camera unit 200 through the display unit 500 and check the situation of traffic congestion or illegal parking ahead in the adjacent lane before changing the lane.

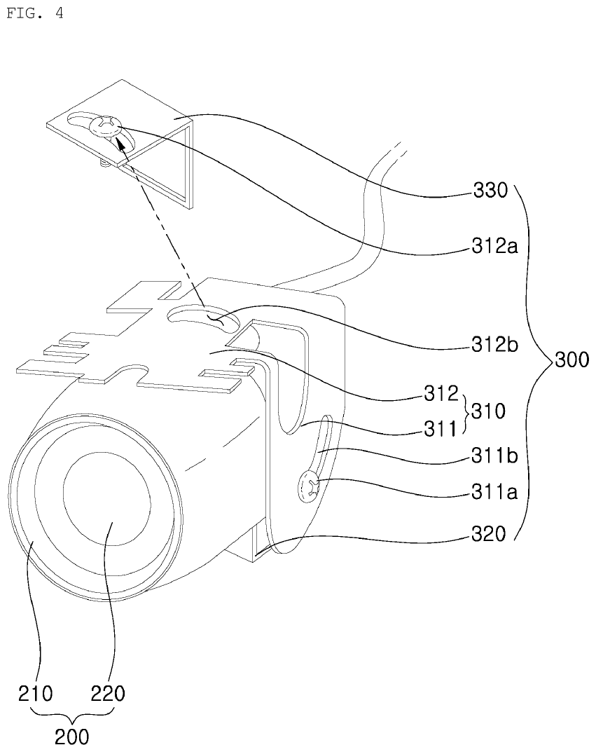

FIG. 4 is a configuration view illustrating a camera unit and a bracket unit according to the exemplary embodiment of the present disclosure.

As shown in FIG. 4, according to the present disclosure, the bracket unit 300 is configured to support the camera unit 200 and fasten the camera unit 200 to the side-view mirror unit 100.

Specifically, the bracket unit 300 is a component for fixing the camera unit 200 built in the side-view mirror unit 100 to a side-view mirror main body 110, and may include: a bracket main body 310; a first bracket connecting end 320; and a second bracket connecting end 330.

The bracket main body 310 is configured in an inversed “L” shape such as to be disposed to cover one surface of the camera unit 200 and a side surface adjacent to the one surface, and may be configured to include a first step 311 and a second step 312.

The first step 311 may be one surface of the bracket main body 310 coupled to the camera unit 200.

In addition, the first step 311 may include: a first fastening screw 311a for fastening the camera unit 200 and the first step 311 to each other; and a first fastening hole 311b into which the first fastening screw 311a is inserted and fixed.

The first fastening hole 311b is configured as a through hole in a longitudinal direction, and allows a fixed position of the first fastening screw 311a to be moved and adjusted to the left or right in order to adjust a position of the camera unit 200.

The second step 312 may be a side surface of the bracket main body 310 coupled to the side-view mirror unit 100.

In addition, the second step 312 may include: a second fastening screw 312a for fastening the side-view mirror unit 100 and the second step 312 to each other; and a second fastening hole 312b into which the second fastening screw 312a is inserted and fixed.

In addition, the second fastening hole 312b is configured as a through hole in a longitudinal direction, and allows a fixed position of the second fastening screw 312a to be moved and adjusted to left or right in order to adjust the position of the camera unit 200.

The first bracket connecting end 320 may be a member connected to fasten the first step 311 and the camera unit 200 to each other.

The second bracket connecting end 330 may be a member connected to fasten the second step 312 and the side-view mirror unit 100 to each other.

FIG. 5 is a use state view illustrating a display unit according to the exemplary embodiment of the present disclosure.

As shown in FIG. 5, according to the present disclosure, the display unit 500 is configured to display the images captured by the camera unit 200.

Specifically, the display unit 500 is a component for displaying images of a traffic situation ahead in an adjacent lane captured by the camera unit 200, and is configured to be displayed on one side of a navigation screen by interworking with an in-vehicle navigation screen with which a user may easily check the images while driving.

In addition, the display unit 500 may be displayed on one side of a navigation content screen executed in the user terminal by interworking with a preset user terminal.

The user terminal is a terminal means for a user to access a navigation system and receive content from the navigation system, and selectively receives a service provided by a website. Particularly, the user terminal is a means to receive content, map information, firmware, etc., which are provided in a size of large file, which may be difficult to receive through a wireless Internet network.

Accordingly, the embodiment of the present disclosure is configured such that traffic information in an adjacent lane captured by the camera unit 200 may be displayed on one side of the navigation content screen executed in the user terminal, so as to provide the traffic information on the adjacent lane captured by the camera unit 200 not only to the in-vehicle navigation screen but also to a driver using navigation content of the user terminal, thereby realizing convenient and safe driving.

Accordingly, the driver will be able to perform efficient lane change after checking the situation ahead in the adjacent lane through the display unit 500 on one side of the navigation content screen executed in the preset user terminal or on the navigation screen displayed on a vehicle interior front.

The connecting end line 400 is a component that electrically connects the camera unit 200 and the display unit 500 to each other.

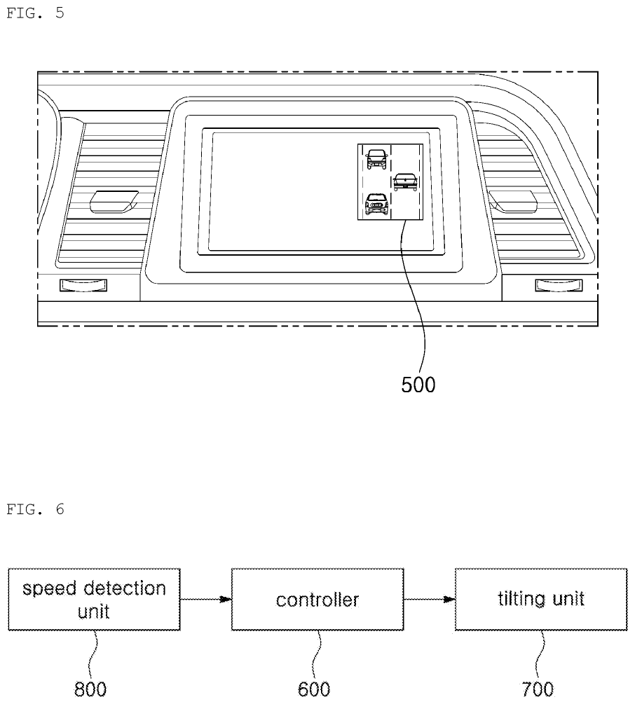

FIG. 6 is a block diagram illustrating a use state of a tilting unit and a controller according to the exemplary embodiment of the present disclosure.

As shown in FIG. 6, according to the present disclosure, the tilting unit 700 is coupled to a rear end of the camera unit 200 and rotates the camera unit 200 vertically and horizontally, so as to enable adjusting the front photographing angle and a photographing position of the camera unit 200.

In addition, the camera unit 200 and the tilting unit 700 may be controlled by the controller 600.

In addition, the vehicle side-view mirror system 10 capable of observing the front in the adjacent lane according to the present disclosure may further include a speed detection unit 800 provided on one side of the side-view mirror unit 100 to detect a driving speed of a vehicle traveling in an adjacent lane.

In this case, when a speed value difference is determined to be greater than or equal to a preset range value by comparing a speed value of the vehicle traveling in the adjacent lane measured by the speed detection unit 800 with a speed value of the present vehicle in motion, the controller 600 adjusts a photographing angle of the camera unit 200 by the tilting unit 700 so as to adjust a front location being captured further or closer, thereby controlling to identify more accurately the situation ahead.

In addition, the controller 600 controls the operation of the tilting unit 700 in order to observe not only a traffic situation ahead in a first lane immediately adjacent to a passenger seat side but also a traffic situation ahead in a second lane adjacent to the first lane, thereby enabling the camera unit 200 to adjust a photographing angle.

Therefore, when changing lanes, through the smooth angle adjustment of the tilting unit 700, a driver will be able to change lanes safely and efficiently by keeping an eye on traffic situations ahead in case of not only changing the current lane to an immediate adjacent lane but also changing the immediate adjacent lane to a next adjacent lane.

That is, since the driver is enabled to check whether there is a large or small amount of traffic ahead in the adjacent lane through the display unit 500, or to check whether there is an illegally parked vehicle ahead in the adjacent lane, the driver will be able to efficiently determine whether to change the current lane or not.

According to the vehicle side-view mirror system capable of observing the front in the adjacent lane according to the present disclosure described above, the vehicle side-view mirror system is provided with the camera disposed inside the side-view mirror on the passenger seat side to face the front toward which direction the vehicle drives, thereby having an effect of not only being able to easily check the vehicle traffic situation ahead in the adjacent lane on the passenger seat side where the driver's view is difficult to be secured, but also preventing the aesthetic problem without causing air resistance due to the camera not protruding out of the side-view mirror.

As described above, the terms or words used in the present disclosure and claims are not to be construed as being limited to their ordinary or dictionary meanings, and should be interpreted as meanings and concepts corresponding to the technical spirit of the present disclosure based on the principle that inventors may properly define the concept of each term in order to best describe their inventive embodiments.

Therefore, the components and configuration shown in the drawings and exemplary embodiment, which are described in the present specification, are only the most preferred exemplary embodiment of the present disclosure, and do not represent all the technical ideas of the present disclosure, and accordingly, it should be appreciated that there may exist various equivalents and modifications at the time when the present application is filed.

### INDUSTRIAL APPLICABILITY

According to the present disclosure, a vehicle side-view mirror system is provided with a camera disposed inside a side-view mirror on a passenger seat side to face the front toward which direction a vehicle drives, thereby having an effect of not only being able to easily check a vehicle traffic situation ahead in an adjacent lane on the passenger seat side where a driver's view is difficult to be secured, but also preventing an aesthetic problem without causing air resistance due to the camera not protruding out of the side-view mirror.

1. A vehicle side-view mirror system capable of checking the front in an adjacent lane, the system comprising:
a side-view mirror unit;
a camera unit built into the side-view mirror unit to capture a view ahead of a vehicle;
a bracket unit for supporting the camera unit and fastening the camera unit to the side-view mirror unit; and
a display unit for displaying images captured by the camera unit.

2. The system of claim 1, wherein the bracket unit comprises a bracket main body composed of a first step fastened to the camera unit and a second step adjacent to and connected to the first step and fastened to the side-view mirror unit, and
the bracket main body is disposed to cover one surface of the camera unit and a side surface adjacent to the one surface.

3. The system of claim 2, wherein the first step comprises:
a first fastening screw for fastening the camera unit and the first step to each other; and
a first fastening hole into which the first fastening screw is inserted and fixed, and
the first fastening hole is configured as a through hole in a longitudinal direction so as to allow a fixing position of the first fastening screw to be adjusted.

4. The system of claim 2, wherein the second step comprises:
a second fastening screw for fastening the side-view mirror unit and the first step to each other; and
a second fastening hole into which the second fastening screw is inserted and fixed, and
the second fastening hole is configured as a through hole in a longitudinal direction so as to allow a fixing position of the second fastening screw to be adjusted.

5. The system of claim 1, wherein the side-view mirror unit comprises:
a main body; and
a transmission window made of a transparent material and provided on one side of the main body facing the front in the adjacent lane.

6. The system of claim 5, wherein, in the camera unit, a lens is disposed adjacent to the transmission window.

7. The system of claim 1, further comprising:
a tilting unit coupled to a rear end of the camera unit and configured to adjust a front photographing angle and a photographing position of the camera unit by rotating the camera unit vertically and horizontally; and
a controller for controlling operations of the camera unit and the tilting unit.

8. The system of claim 1, wherein the display unit interworks with a vehicle navigation system and is displayed on one side of a navigation screen, or interworks with a preset user terminal and is displayed on one side of a navigation content screen executed in the user terminal.
